(19) United States
(12) Patent Application Publication
(10) Pub. No.: US 2020/0042962 A1
(43) Pub. Date: Feb. 6, 2020

(54) INTEGRATED FINANCIAL TRANSACTION HISTORY MANAGEMENT SYSTEM AND FINANCIAL TRANSACTION MANAGEMENT METHOD USING SAME

(71) Applicants: In Beom WANG, Seoul (KR); Woo Jeon CHOI, Seoul (KR)

(72) Inventors: In Beom WANG, Seoul (KR); Woo Jeon CHOI, Seoul (KR)

(21) Appl. No.: 16/486,837

(22) PCT Filed: Feb. 21, 2018
(86) PCT No.: PCT/KR2018/002105

§ 371 Date: Aug. 19, 2019

(30) Foreign Application Priority Data
Feb. 22, 2017 (KR) 10-2017-0023524
Feb. 22, 2017 (KR) 10-2017-0182279

(51) Int. Cl. G06Q 20/08; G06Q 20/10

(52) U.S. Cl. CPC G06Q 20/085; G06Q 20/1085

(57) ABSTRACT

The present invention relates to an integrated financial transaction history management system and a financial transaction management method using same. The integrated financial transaction history management system comprises: a transaction settlement system which enables a user to check a financial transaction conducted through a financial institution, and a request for a financial transaction made by using a card; an integrated management server which checks and approves the financial transaction requested via the transaction settlement system, thereby enabling the financial transaction of the user to be executed, and which creates a database of information on the approved financial transaction and stores same in a financial transaction DB; and a user terminal which enables setting a financial transaction period and classifications by category via a dedicated program provided by the integrated management server, and then requesting for a financial transaction history and receiving same, wherein the integrated management server comprises a user rights control unit which, when a request for changing the user rights for a financial transaction is made on the user terminal via the dedicated program, receives the user rights request, changes the user rights and provides same.

### TECHNICAL FIELD

The present invention relates to a financial transaction details integrated managing system and a financial transaction managing method using the same.

### BACKGROUND ART

Generally, a credit card company provides card transaction approval details in text messages, which may be useful for the user to identify the details of card use but, since it is in the form of text data, its accumulation, processing, or other use may be limited.

Recently, most of users use multiple cards but rather than a single credit card. Card companies may be associated with banks. Upon using bank accounts and multiple cards associated with banks, the user may need to comprehensively manage use details which are provided per card and per detail.

### DETAILED DESCRIPTION OF THE INVENTION

### Technical Problem

The present invention has been conceived to address the foregoing issues and aims to provide a financial transaction details integrated managing system which may manage financial transactions in an integrated manner by allowing the user to set and identify periods and categories for financial transaction details, controlling the use authority of financial transactions, and enabling going Dutch and a financial transaction managing method using the same.

### Technical Solution

To achieve the foregoing objectives, according to the present invention, a financial transaction details integrated managing system and a financial transaction managing method using the same comprise a transaction payment system to identify a user's financial transaction using a financial organization and a request for the financial transaction through a payment means, an integrated managing server to identify and approve the financial transaction requested through the transaction payment system to perform the user's financial transaction, create a database for information about the approved financial transaction, and store the database in a financial transaction DB, and a user terminal to set a classification per category and per financial transaction period through a dedicated program provided by the integrated managing server, send a request for financial transaction details, and receive the financial transaction details, wherein the integrated managing server further includes a use authority controller that, when the user terminal requests to change a use authority of the financial transaction through the dedicated program, receives the use authority request and changes and provides the use authority.

The use authority the request for which is sent to the use authority controller may be any one of whether to be withdrawn or not via an ATM, whether payment on the payment means is approved, whether foreign payment on the payment means is approved, a withdrawal limit setting, and a payment means use limit setting.

The integrated managing server may further include an approval controller that identifies and approves the financial transaction requested through the transaction payment system to allow the user's financial transaction to be performed, provides the approved financial transaction information to the user terminal, and recognizes and classifies the approved financial transaction information.

In a case where the financial transaction approved by the approval controller is use of a credit card, the financial transaction information provided from the approval controller to the user terminal may be card spending, total credit limit, remaining credit, and total spending relative to target spending.

In a case where the financial transaction approved by the approval controller is use of a check card, the financial transaction information provided from the approval controller to the user terminal may be card spending, remaining account balance, and total spending relative to target spending.

In a case where the financial transaction approved by the approval controller is use of a stored-value card, the financial transaction information provided from the approval controller to the user terminal may be card spending, remaining balance, and total spending relative to target spending.

The integrated managing server may further include a transmission/reception unit to transmit and receive data to/from the user terminal and multiple transaction payment systems, a financial transaction DB to create the financial transaction information recognized and classified by the approval controller into per-item tables and store the per-item tables, and a details extracting/providing unit to extract financial transaction details requested through the user terminal from the financial transaction information stored in the financial transaction DB and provide the extracted financial transaction details.

The financial transaction details provided from the details extracting/providing unit to the user terminal may include use details of each affiliate store in a representative affiliate store category.

The integrated managing server may further include a split payment controller that receives a request for split payments between multiple users registered as friends for spending from the user terminal, calculates split payments for details of the spending, and send a payment confirm message to each of the friends' terminals to request a payment.

Through the dedicated program, the user terminal may set a period and category for, and extract, any one of details of spending with the payment means for a predetermined period, details of spending per payment means for a predetermined period, details of spending per affiliate store for a predetermined period, details of deposit/withdrawal to/from all possessed accounts for a predetermined period, and details of deposit/withdrawal per account for a predetermined period.

A financial transaction details integrated managing system and a financial transaction managing method using the same comprise identifying, by a transaction payment system, a user's financial transaction using a financial organization and a request for the financial transaction through a payment means, identifying and approving, by an integrated managing server, the financial transaction requested through the transaction payment system to perform the user's financial transaction, and transmit information about the approved financial transaction to a user terminal, running a dedicated program for using the integrated managing server on the user terminal, setting a classification per category and per financial transaction period through, and then sending a request for financial transaction details, extracting and providing the financial transaction details requested by the user terminal, requesting, by the user terminal, to change a use authority of the financial transaction through the dedicated program, and receiving the use authority request, changing, and providing the use authority, by the integrated managing server.

According to the present invention, a financial transaction details integrated managing system comprises a transaction payment system to identify a user's financial transaction using a financial organization and a request for the financial transaction through a payment means, an integrated managing server to identify and approve the financial transaction requested through the transaction payment system to perform the user's financial transaction, create a database for information about the approved financial transaction, and store the database in a financial transaction DB, and a user terminal to set a classification per category and per financial transaction period through a dedicated program provided by the integrated managing server, send a request for financial transaction details, and receive the financial transaction details, wherein the integrated managing server includes a use authority controller that identifies and approves the financial transaction requested through the transaction payment system to perform the user's financial transaction, provides the approved financial transaction information to the user terminal, and recognizes and classifies the approved financial transaction information, a transmission/reception unit that transmits and receives data to/from the user terminal and multiple transaction payment systems, a financial transaction DB that creates and stores per-item tables for the financial transaction information recognized and classified by the approval controller, and a details extracting/providing unit that extracts financial transaction details requested by the user terminal from the financial transaction information stored in the financial transaction DB and provides the extracted financial transaction details.

When the financial transaction approved by the approval controller is use of a credit card, the financial transaction information provided from the approval controller to the user terminal is card spending, when the financial transaction approved by the approval controller is use of a check card, the financial transaction information provided from the approval controller to the user terminal is the amount spent, and when the financial transaction approved by the approval controller is use of a stored-value card, the financial transaction information provided from the approval controller to the user terminal is the amount spent.

The financial transaction details provided from the details extracting/providing unit to the user terminal may include use details of each affiliate store in a representative affiliate store category.

In a case where the financial transaction approved by the approval controller is use of a credit card, the financial transaction information provided from the approval controller to the user terminal may be card spending, total credit limit, remaining credit, and total spending relative to target spending.

Through the dedicated program, the user terminal may set a period and category for, and extract, any one of details of spending with the payment means for a predetermined period, details of spending per payment means for a predetermined period, details of spending per affiliate store for a predetermined period, details of deposit/withdrawal to/from all possessed accounts for a predetermined period, and details of deposit/withdrawal per account for a predetermined period.

### Advantageous Effects

According to the present invention, the financial transaction details integrated managing system and financial transaction managing method using the same allow the user to set and identify periods and categories for financial transaction details, control use authority for financial transactions, and go Dutch, thereby managing financial transactions in an integrated manner.

### BRIEF DESCRIPTION OF DRAWINGS

FIG. 1 is a view illustrating a configuration of a financial transaction details integrated managing system according to an embodiment of the present invention;

FIG. 2 is a block diagram illustrating a configuration of an integrated managing server in the financial transaction details integrated managing system of FIG. 1; and

FIG. 3 is a flowchart illustrating a method of operation of each component in the financial transaction details integrated managing system of FIG. 1.

### MODE FOR CARRYING OUT THE INVENTION

Hereinafter, embodiments of the present invention are described in detail with reference to the accompanying drawings. Embodiments of the disclosure are provided to thoroughly explain the disclosure to those skilled in the art, and various modifications may be made thereto, and the scope of the present invention is not limited thereto. Embodiments of the disclosure are provided to fully and thoroughly convey the spirit of the present invention to those skilled in the art.

As used herein, the thickness and size of each layer may be exaggerated for ease or clarity of description. The same reference denotations may be used to refer to the same or substantially the same elements throughout the specification and the drawings. As used herein, the term “A and/or B” encompasses any, or one or more combinations, of A and B. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

The terms as used herein are provided merely to describe some embodiments thereof, but not intended as limiting the present invention. As used herein, the singular forms “a,” “an,” and “the” are intended to include the plural forms as well, unless the context clearly indicates otherwise. As used herein, the term “comprise,” “include,” and/or “comprising” or “including” does not exclude the presence or addition of one or more other components, steps, operations, and/or elements than the component, step, operation, and/or element already mentioned.

As used herein, the terms “first” and “second” may be used to describe various members, parts, regions, areas, layers, and/or portions, but the members, parts, regions, areas, layers, and/or portions are not limited thereby. These terms are used merely to distinguish one member, part, region, area, layer, or portion from another. Accordingly, the term “first member,” “first part,” “first region,” “first area,” “first layer,” or “first portion” described herein may denote a “second member,” “second part,” “second region,” “second area,” “second layer,” or “second portion” without departing from the teachings disclosed herein.

The terms “beneath,” “below,” “lower,” “under,” “above,” “upper,” “on,” or other terms to indicate a position or location may be used for a better understanding of the relation between an element or feature and another as shown in the drawings. However, embodiments of the present invention are not limited thereby or thereto. For example, where a lower element or an element positioned under another element is overturned, then the element may be termed as an upper element or element positioned above the other element. Thus, the term “under” or “beneath” may encompass, in meaning, the term “above” or “over.”

According to the present invention, integrated managing server and financial organization server may be implemented in hardware, firmware, application specific integrated circuits (ASICs), software, or a combination thereof. According to the present invention, various components of integrated managing server and financial organization server may be implemented in a single integrated circuit (IC) chip or individually in multiple IC chips. Further, various components of the system may be implemented on a flexible printed circuit board, in a tape carrier package, or on a printed circuit board. Further, various components of the integrated managing server and financial organization server may be processes, threads, operations, instructions, or commands executed on one or more processors in one or more computing devices, which may execute computer programming instructions or commands to perform various functions described herein and interwork with other components. The computer programming instructions or commands may be stored in a memory to be executable on a computing device using a standard memory device, e.g., a random access memory (RAM). The computer programming instructions or commands may be stored in, e.g., a compact-disc read only memory (CD-ROM), flash drive, or other non-transitory computer readable media. It will be appreciated by one of ordinary skill in the art that various functions of the computing device may be combined together or into a single computing device or particular functions of a computing device may be distributed to one or other computing devices without departing from the scope of the present invention.

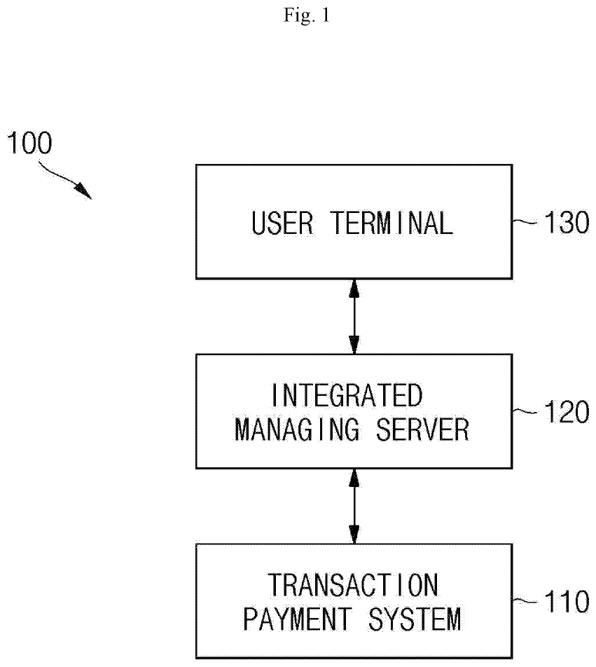

FIG. 1 is a view illustrating a configuration of a financial transaction details integrated managing system according to an embodiment of the present invention. Referring to FIG. 1, a financial transaction details integrated managing system 100 includes a transaction payment system 110, an integrated managing server 120, and a user terminal 130. The transaction payment system 110, the integrated managing server 120, and the user terminal 130 may transmit or receive data via a wired/wireless network. The wired/wireless network may use at least one of LAN (local area network), WLAN (wireless LAN), Wibro (wireless broadband), Wimax (world interoperability for microwave access), HSDPA (high speed downlink packet access), and other various communication standards.

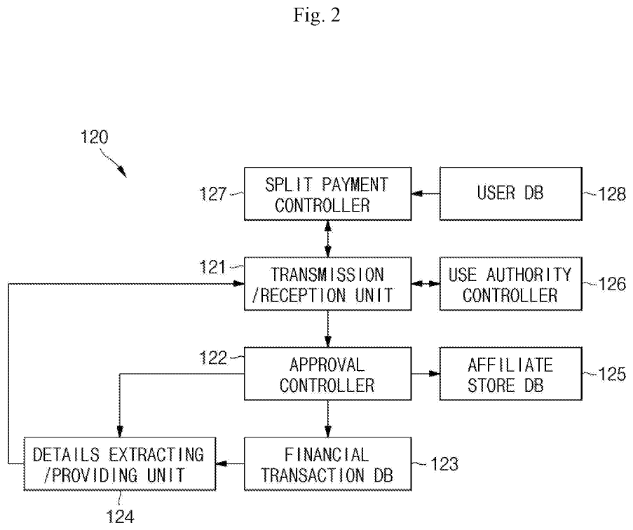

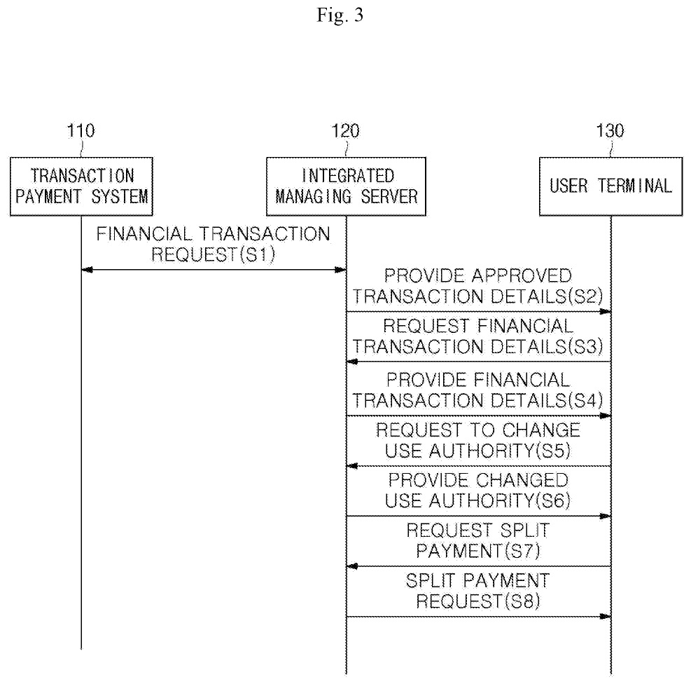

The integrated managing server 120 includes a transmission/reception unit 121, an approval controller 122, a financial transaction DB 123, a details extracting/providing unit 124, an affiliate store DB 125, a use authority controller 126, a split payment controller 127, and a user DB 128 as shown in FIG. 2. FIG. 3 is a flowchart illustrating a method of operation between components of the financial transaction details integrated managing system 100 of FIG. 1.

Hereinafter, each component and operation method of the financial transaction details integrated managing system 100 are described in detail with reference to FIGS. 1, 2, and 3.

The transaction payment system 110 may be a device or program (including an application) through which the user may identify various financial transactions, use of cards in external affiliate stores, or use transactions in bank using his personal terminal (hereinafter, the “user terminal” 130). For example, the transaction payment system 110 may be any one of the affiliate store's card reader, the card payment system (including an application) of the user terminal 130, the bank or securities company system (including an application) of the user terminal 130, the FinTech payment system (including an application) of the user terminal 130, a bank ATM (automatic teller's machine), and a bank or securities company's teller machine, but the present invention is not limited thereto. Further, the integrated managing server 120 may be the managing server of one financial organization, e.g., a bank, card company, or securities company. For example, where the integrated managing server 120 is a bank's server, the transaction payment system 110 may be any one of the affiliate store's card reader, the card payment system (including an application) of the user terminal 130, the bank system (including an application) of the user terminal 130, the FinTech payment system (including an application) of the user terminal 130, a bank ATM (automatic teller's machine), and a bank's teller machine. To clarify the description of the integrated managing server 120, the description focuses primarily on banks where credit cards, check cards, and stored-value cards can be used.

Here, the user terminal 130 may be a laptop computer, desktop computer, or other personal computers, a Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smartphone, a smart pad, tablet PC, or any other various types of handheld wireless communication devices, but the present invention is not limited thereto. Further, the bank teller machine may be a laptop computer, desktop computer, or other personal computers, but the present invention is not limited thereto.

In other words, the transaction payment system 110 may be a system (including an application) or device capable of identifying financial transactions or requests for financial transactions via payment means which the user performs through a financial organization. The transaction payment system 110 may be provided with multiple devices or programs to identify the user's financial transactions. Here, the payment means may include a card, e.g., a credit card, check card, and stored-value card and FinTech which is payment means using the user terminal 130.

The integrated managing server 120 identifies the user's financial transaction request S1 performed through multiple transaction payment systems 110 and approves the financial transaction so that the financial transaction on bank or payment on payment means is performed. Further, the integrated managing server 120 may create a database of the approved financial transaction request details and store the database, extract the financial transaction details requested from the user terminal 130, and provide the extracted details to the user terminal 130.

The user terminal 130 may run a web program or mobile application (hereinafter, “dedicated program”) provided from the integrated managing server 120 and receive the user's financial transaction details from the integrated managing server 120. The dedicated program may be installed on the user terminal 130 and, after user authentication and login, may be used. The user terminal 130 may have a dedicated program installed and run thereon, register account information by which financial transactions can be performed and information about payment means and store user information in the user DB 128 of the integrated managing server 120. Further, although one user terminal 130 is shown, the integrated managing server 120 may transmit and receive data via a wired/wireless network with multiple user terminals with a dedicated program installed.

The transmission/reception unit 121 may receive financial transactions requested (S1) by the multiple transaction payment systems 110 and provide them to the approval controller 122. The transmission/reception unit 121 may receive all data transmitted from the transaction payment system 110 and user terminal 130 to the integrated managing server 120 and transmit all data transmitted from the integrated managing server 120 to the transaction payment system 110 and the user terminal 130. In other words, the transmission/reception unit 121 plays a role as a counter when the integrated managing server 120 transmits data with the transaction payment system 110 and the user terminal 130 via the wired/wireless network. Here, data may be, e.g., financial transaction requests and provision of approval details, transaction details request and provision, use authority change requests and provision, split payment requests and provision.

The approval controller 122 may identify and approve the financial transaction request received through the transmission/reception unit 121 so that financial transaction may be made on the transaction payment system 110. Further, where the approval controller 122 approves the requested financial transaction, the approval controller 122 notifies the transaction payment system 110 that the financial transaction is approved through the transmission/reception unit 121 and allows the financial transaction to be performed through the transaction payment system 110. Further, where the requested financial transaction is approved, the approval controller 122 may provide (S2) information about the approved financial transaction through the transmission/reception unit 121 to the user terminal 130. The approved financial transaction information may differ per financial transaction detail. Here, where the approved financial transaction is deposit or withdrawal through bank, the financial transaction information provided to the user terminal 130 may be the amount deposited or the amount withdrawn or balance information. Where the approved financial transaction is credit card or its corresponding FinTech payment, the financial transaction information provided to the user terminal 130 may be, e.g., the amount paid, total credit, remaining credit, total spending relative to target spending. Where the approved financial transaction is check card or its corresponding FinTech payment, the financial transaction information provided to the user terminal 130 may be, e.g., the amount paid, remaining credit, and total spending relative to target spending. Where the approved financial transaction is stored-value card or its corresponding FinTech payment, the financial transaction information provided to the user terminal 130 may be, e.g., the amount paid, remaining credit, and total spending relative to target spending. Here, stored-value card may be a card which may be loaded a predetermined amount and then used. Here, target spending may be the target spending within a period preset on the user terminal 130, and total spending may be the total spending made by the user using the card or withdrawal for financial transactions during the same period as the preset period.

For example, where the target spending is set as a monthly target spending on the user terminal 130, the total spending may be the sum of the user's spending on all financial payment means and withdrawal from all accounts from the first day of each month to the currently approved financial transaction.

Further, the approval controller 122 may recognize and separate the approved financial transaction information per item and store them in the financial transaction DB 123. Here, items of financial transaction information may differ per financial transaction detail. For example, where the approved financial transaction information is financial information by the payment means, the approval controller 122 recognizes and divides the information into items, such as date of transaction, amount paid, name of affiliate store, use item, name of representative affiliate store, affiliate store code, card number, installment pay or not, total payment limit, remaining limit, account balance, and total spending, create a table for the items, and store them per item in the financial transaction DB 123.

Although different affiliate store names are recognized and divided by the approval controller 122, the representative affiliate store name may be extracted from the affiliate store DB 125 and added and stored in the financial transaction DB 123. The affiliate store DB 125 may store affiliate store names, affiliate store codes, and representative affiliate store names. Here, representative affiliate store name may denote the brand name in the case of affiliate stores under the same franchise, and in this case, the affiliate store names may be combinations of the brand name and branch names. For example, where the affiliate store name recognized and divided by the approval controller 122 is “YY brand XX branch,” its representative affiliate store name, i.e., “YY brand,” for “YY brand XX branch” may be extracted and the affiliate store name and the representative affiliate store name all may be stored in the financial transaction DB 123.

That is, the approval controller 122 may store both affiliate store names and their super ordinate concept, i.e., representative affiliate store name in the financial transaction DB 123 for more comprehensive identification of the user's financial transaction details and easier analysis (of trend).

Further, the affiliate store DB 125 may periodically add, and be updated with, new affiliate store information. The update of the affiliate store DB 125 may be performed by the person in charge of managing the integrated managing server 120 in the financial organization.

The use items stored in the financial transaction DB 123 may be spending items set per representative affiliate store by the user through the dedicated program on the user terminal 130. For example, where the spending on the ZZ brand, which is the representative affiliate store, is set to be a “meal expense” item via the dedicated program on the user terminal 130, if the user uses the payment means in multiple affiliate stores (branches), the use item may be categorized and stored as “meal expense.”

Where the approved financial transaction information is financial transaction information such as deposit/withdrawal in bank, the approval controller 122 may recognize the information per item, e.g., date of transaction, amount, details of transaction, account number (name), deposit/withdrawal, account balance, and total spending and store them per item in the financial transaction DB 123.

As such, multiple pieces of financial transaction information are created into per-item databases which are then stored in the financial transaction DB 123. Further, the financial transaction DB 123 may store use details per payment means and details of financial transactions on bank. For example, where per-payment means use details and information about financial transactions on bank are together stored in the financial transaction DB 123, they may be stored with inconsistent items between per-payment use details and bank financial transaction details left blank. For example, since the per-payment means use details lack such items as deposit/withdraw and account number, the deposit/withdrawal and account number items may remain blank in the financial transaction DB 123.

The details extracting/providing unit 124 runs the dedicated program on the user terminal 130 and then extracts the requested (S3) financial transaction details and provide (S4) the extracted details through the transmission/reception unit 121 to the user terminal 130. At this time, upon sending the request (S3) to extract financial transaction details to the details extracting/providing unit 124, the user terminal 130 may set, e.g., a financial transaction period and per-category classification. The user terminal 130 may set a period and category for, and extract through the dedicated program, use details using payment means, per-payment means use details for a predetermined period, per-representative affiliate store use details for a predetermined period, deposit/withdrawal details from all possessed accounts for a predetermined period, and per-account deposit/withdrawal details for a predetermined period. Further, the use details received through the dedicated program of the user terminal 130 may include per-affiliate store (per-branch) use details in the representative affiliate store category. For example, where the user terminal 130 extracts the use details on the payment means for one month, the details extracting/providing unit 124 may provide per-use item use details, use details for each of the multiple representative affiliate stores in the use item category, and use details for each affiliate store (branch) in the representative affiliate store category. Hence, it is possible to identify all of the per-affiliate store (branch) use details included in the representative affiliate store and the per-representative affiliate store use details through the received use details. Further, the details extracting/providing unit 124 may also provide information about the total spending relative to target spending for the user's preset period.

The user may extract the financial transaction details on the user terminal 130 through the details extracting/providing unit 124 of the integrated managing server 120 and identify his expense details, patterns, deposit/withdrawal details, deposit/withdrawal patterns, and financial transaction details, thus eliminating the need for a housekeeping book and allowing for organized expense plan.

The details extracting/providing unit 124 may provide (S4) the financial transaction details to be identified by the dedicated program of the user terminal 130 and may be provided to be downloaded in PDF, image, or excel file format. However, the present invention is not limited to the above file formats in which the financial transaction details are provided.

If the user terminal 130 runs the dedicated program and sends a request (S5) to change the use authority of financial transaction, the use authority controller 126 receives the use authority change request through the transmission/reception unit 121. The use authority controller 126 changes the requested use authority and provides (S6) it to the user terminal 130. The user terminal 130 may provide a notification window to indicate that the use authority has been changed on the dedicated program.

In other words, the user terminal 130 may set, through the dedicated program, whether to withdraw cash on ATM, whether to approve payment on payment means, whether to approve foreign payment on payment means, withdrawal limit, and use limit of payment means. Further, the use authority controller 126 of the integrated managing server 120 may change and provide the use authority requested through the user terminal 130.

For example, where withdrawal on ATM for at least one selected from the user's multiple accounts is requested to be blocked through the dedicated program of the user terminal 130, the use authority controller 126 of the integrated managing server 120 may set the at least one account requested by the user to be blocked for withdrawal on ATM.

As such, in response to the request for changing use authority made through the dedicated program of the user terminal 130, a change may be made in real-time through the use authority controller 126 of the integrated managing server 120, and card loss or theft may be handled more easily.

The split payment controller 127 may calculate individual payments for use details when receiving a split payment (go Dutch) request (S7) among multiple users registered as friends for the used amount from the user terminal 130 and send payment confirm messages to the friends' user terminals (hereinafter, “friends' terminals” 140) for payment request (S8). At this time, the split payment controller 127 of the integrated managing server 120 may receive the split payment request through the transmission/reception unit 121 and send a split payment request.

More specifically, the user terminal 130 may select the phone numbers of the friends who are to separately pay from the phone numbers stored in the user terminal 130 for the spent amount selected from the user's use details provided from the details extracting/providing unit 124 and send a request (S7) for going Dutch with the friends for the amount spent to the integrated managing server 120. The split payment controller 127 of the integrated managing server 120 may split the requested amount spent into 1/N and send a payment confirm text message to each friend's terminal 130 for the split payments to thereby make a payment request. Here, N may be the sum of the number of the friends and the user. For example, where there are four friends who go Dutch, N may be five which includes the user. The payment confirm text message may include a link to access the dedicated program, the amount of payment as split, the user's representative account number, and information about the friends who go Dutch. Each friend's terminal 130, upon receiving the split payment request text message, may click on the link in the text message to thereby automatically transfer his amount to the representative account of the user terminal 130. In the automatic transfer, if the friends' terminals 130 give approval on the split payment request, the split payment controller 127 of the integrated managing server 120 may extract the friends' representative accounts and the user's representative account stored in the user DB 128 and may thereby perform automatic transfer. Unless the friends' user terminal 130 have the dedicated program for use of the integrated managing server 120 installed yet, transfer may be performed by visiting bank or a separate bank system (application) by referencing the split payment amount and account number included in the text message.

As such, the financial transaction details integrated managing system 100 enables integrated management of financial transactions including the control of use authority of financial transactions and enabling split payments as well as identifying financial transaction details.

While the present invention has been shown and described with reference to exemplary embodiments of the financial transaction details integrated managing system and financial transaction managing method using the same, it will be apparent to those of ordinary skill in the art that various changes in form and detail may be made thereto without departing from the spirit and scope of the disclosure as defined by the following claims.

1. A financial transaction details integrated managing system, comprising:
a transaction payment system to identify a user's financial transaction using a financial organization and a request for the financial transaction through a payment means;
an integrated managing server to identify and approve the financial transaction requested through the transaction payment system to perform the user's financial transaction, create a database for information about the approved financial transaction, and store the database in a financial transaction DB; and
a user terminal to set a classification per category and per financial transaction period through a dedicated program provided by the integrated managing server, send a request for financial transaction details, and receive the financial transaction details, wherein the integrated managing server further includes a use authority controller that, when the user terminal requests to change a use authority of the financial transaction through the dedicated program, receives the use authority request and changes and provides the use authority.

2. The financial transaction details integrated managing system of claim 1, wherein the use authority the request for which is sent to the use authority controller is any one of whether to be withdrawn or not via an ATM, whether payment on the payment means is approved, whether foreign payment on the payment means is approved, a withdrawal limit setting, and a payment means use limit setting.

3. The financial transaction details integrated managing system of claim 1, wherein the integrated managing server further includes an approval controller that identifies and approves the financial transaction requested through the transaction payment system to allow the user's financial transaction to be performed, provides the approved financial transaction information to the user terminal, and recognizes and classifies the approved financial transaction information.

4. The financial transaction details integrated managing system of claim 3, wherein in a case where the financial transaction approved by the approval controller is use of a credit card, the financial transaction information provided from the approval controller to the user terminal is card spending, total credit limit, remaining credit, and total spending relative to target spending.

5. The financial transaction details integrated managing system of claim 3, wherein in a case where the financial transaction approved by the approval controller is use of a check card, the financial transaction information provided from the approval controller to the user terminal is card spending, remaining account balance, and total spending relative to target spending.

6. The financial transaction details integrated managing system of claim 3, wherein in a case where the financial transaction approved by the approval controller is use of a stored-value card, the financial transaction information provided from the approval controller to the user terminal is card spending, remaining balance, and total spending relative to target spending.

7. The financial transaction details integrated managing system of claim 3, wherein the integrated managing server further includes a transmission/reception unit to transmit and receive data to/from the user terminal and multiple transaction payment systems; a financial transaction DB to create the financial transaction information recognized and classified by the approval controller into per-item tables and store the per-item tables; and a details extracting/providing unit to extract financial transaction details requested through the user terminal from the financial transaction information stored in the financial transaction DB and provide the extracted financial transaction details.

8. The financial transaction details integrated managing system of claim 7, wherein the financial transaction details provided from the details extracting/providing unit to the user terminal include use details of each affiliate store in a representative affiliate store category.

9. The financial transaction details integrated managing system of claim 1, wherein the integrated managing server further includes a split payment controller that receives a request for split payments between multiple users registered as friends for spending from the user terminal, calculates split payments for details of the spending, and send a payment confirm message to each of the friends' terminals to request a payment.

10. The financial transaction details integrated managing system of claim 1, wherein through the dedicated program, the user terminal sets a period and category for, and extracts, any one of details of spending with the payment means for a predetermined period, details of spending per payment means for a predetermined period, details of spending per affiliate store for a predetermined period, details of deposit/withdrawal to/from all possessed accounts for a predetermined period, and details of deposit/withdrawal per account for a predetermined period.

11. A financial transaction managing method using a financial transaction details integrated managing system, comprising:
identifying, by a transaction payment system, a user's financial transaction using a financial organization and a request for the financial transaction through a payment means;
identifying and approving, by an integrated managing server, the financial transaction requested through the transaction payment system to perform the user's financial transaction, and transmit information about the approved financial transaction to a user terminal;
running a dedicated program for using the integrated managing server on the user terminal, setting a classification per category and per financial transaction period through, and then sending a request for financial transaction details;
extracting and providing the financial transaction details requested by the user terminal;
requesting, by the user terminal, to change a use authority of the financial transaction through the dedicated program; and
receiving the use authority request, changing, and providing the use authority, by the integrated managing server.

12. A financial transaction details integrated managing system, comprising:
a transaction payment system to identify a user's financial transaction using a financial organization and a request for the financial transaction through a payment means;
an integrated managing server to identify and approve the financial transaction requested through the transaction payment system to perform the user's financial transaction, create a database for information about the approved financial transaction, and store the database in a financial transaction DB; and
a user terminal to set a classification per category and per financial transaction period through a dedicated program provided by the integrated managing server, send a request for financial transaction details, and receive the financial transaction details, wherein the integrated managing server includes a use authority controller that identifies and approves the financial transaction requested through the transaction payment system to perform the user's financial transaction, provides the approved financial transaction information to the user terminal, and recognizes and classifies the approved financial transaction information, a transmission/reception unit that transmits and receives data to/from the user terminal and multiple transaction payment systems, a financial transaction DB that creates and stores per-item tables for the financial transaction information recognized and classified by the approval controller, and a details extracting/providing unit that extracts financial transaction details requested by the user terminal from the financial transaction information stored in the financial transaction DB and provides the extracted financial transaction details.

13. The financial transaction details integrated managing system of claim 12, wherein when the financial transaction approved by the approval controller is use of a credit card, the financial transaction information provided from the approval controller to the user terminal is card spending, when the financial transaction approved by the approval controller is use of a check card, the financial transaction information provided from the approval controller to the user terminal is the amount spent, and when the financial transaction approved by the approval controller is use of a stored-value card, the financial transaction information provided from the approval controller to the user terminal is the amount spent.

14. The financial transaction details integrated managing system of claim 12, wherein the financial transaction details provided from the details extracting/providing unit to the user terminal include use details of each affiliate store in a representative affiliate store category.

15. The financial transaction details integrated managing system of claim 12, wherein through the dedicated program, the user terminal sets a period and category for, and extracts, any one of details of spending with the payment means for a predetermined period, details of spending per payment means for a predetermined period, details of spending per affiliate store for a predetermined period, details of deposit/withdrawal to/from all possessed accounts for a predetermined period, and details of deposit/withdrawal per account for a predetermined period.
